(19) United States
(12) Patent Application Publication
(10) Pub. No.: US 2007/0132147 A1
(43) Pub. Date: Jun. 14, 2007

(54) Molding Machine and Locking Mechanism

(75) Inventor: Peter Adrian LOOIJE, Newmarket, ON (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton, ON (CA)

(21) Appl. No.: 11/673,740

(22) Filed: Feb. 12, 2007

Related U.S. Application Data
(63) Continuation-in-part of application No. 10/875,027, filed on Jun. 24, 2004, now abandoned.

(51) Int. Cl. B29C 45/00; B29C 45/66

(52) U.S. Cl. 264/328.1; 425/589

(57) ABSTRACT

Disclosed is, according to an embodiment, a molding machine has a clamp piston assembly that includes: (i) a body portion having a channel extending through the body portion, the channel including a pocket into which is mounted, in use, a first set of contact pads, the body portion being transmittable of a clamping force, and (ii) a clamp bushing being receptive of the clamping force from the body portion, the clamp bushing being lockably engagable with a tie bar, the clamp bushing having an external surface to which is mounted, in use, a second set of contact pads, the clamp bushing being locatable and rotatable within the pocket, the first set of contact pads and the second set of contact pads cooperate to define at least two fluid sealable chambers, and responsive to pressurization of fluid placed any one of the at least two fluid sealable, the clamp bushing is rotated so as to become lock engaged with the tie bar.

### CROSS-REFERENCE TO RELATED APPLICATIONS

The present application is a continuation-in-part of, and claims priority under U.S.C. §120, U.S. patent application Ser. No. 10/875,027, filed 24 Jun. 2004.

### FIELD OF THE INVENTION

This invention relates, in general, to a molding machines having a clamping (or locking) mechanism that acts in association with a press (or the like) to develop, ultimately, a clamp force or closure tonnage. The present invention is more particularly, but not exclusively, applicable to the configuration of a clamp piston assembly that is used to securely clamp up, during a molding process and particularly an injection molding process, a tie bar (also known as a column) to a platen to produce a closed force path.

### BACKGROUND

From the exemplary perspective of an injection molding environment, system designers are faced with having to provide reliable and robust clamping systems that operate for extended periods with minimum, if any, maintenance. More particularly, clamp units and clamp assemblies in injection molding machines are designed to run on an almost continuous basis for weeks at a time, if not months at a time. Typically, machine cycle times range from a few seconds to a couple of minutes, with the cycle generally determined by part weight. As such, clamp-up time, i.e. the time required to positively engage the tie bar or column and to apply closure tonnage, sometimes has considerable impact for productivity. Consequently, in certain applications, clamp-up speed is important.

In the injection molding of large articles, such as in the molding of car body parts and the like, the injection molding machines also develop considerable closure tonnage. Indeed, if is not unusual for machines in large tonnage applications to range from 1000 tons of closure pressure to 8000 tons of closure pressure. In view of the forces involved, particularly in large tonnage applications above about 800 tons, the physical scale of components and their construction is both large and strong, respectively. With a typical clamp assembly made from steel, its weight alone can be in the region of about 500 to 1000 kilograms. Such a clamp assembly (including its associated actuation pistons) is fixedly attached to the moving platen (for example).

Even with smaller applications, such as in the production of PET preforms, machines typically must develop something in the range of between 300 and 600 tons of closure pressure.

In terms of achieving clamping of the tie bar into the platen (i.e. through positive engagement of the tie bar or column into the clamp piston), each tie bar or column may include at least one integrally formed annulus of protruding teeth extending from the surface of the cast-steel tie bar or column. There may be more than one annulus of teeth. Of course, rather than an annulus of teeth, an alternative interlocking mechanism may be realised by rings of notches that are cut into the surface of the tie bar or column. Also, as will become apparent, to allow relative longitudinal movement of the tie bar with respect base of the injection unit, each annulus includes at least one channel that is transverse to and disrupts the circumferential continuity of the teeth (or notch). Within the clamp piston, a second set of teeth (or notches) is arranged to be selectively inter-locking with the corresponding teeth in the tie bar, with the clamp piston therefore dimensioned to closely surround the tie bar. Again, the circumferential continuity of the rows of teeth (or notches) in the internal surface of the clamp piston are disrupted by at least one channel. Longitudinal alignment of the teeth in the clamp piston with the channel through the teeth (or notch) of the tie bar (or column) thereby permits axial movement of the tie bar relative to the clamp piston. Conversely, matched alignment and inter-locking of the respective sets of teeth in both the tie bar and clamp piston establishes positive engagement and the subsequent ability to develop clamp force through the inter-locking teeth and the application of hydraulic force on a piston surface within the clamp assembly.

In existing systems, such as described in European Patent Number A-0904918, the entire annularly-shaped clamp piston is rotated to cause selective interlocking engagement and disengagement of the teeth. Since the injection molding machine described in this document contains four tie bars each having an associated clamp piston, a synchronized, mechanically-driven rotation of the entire clamp piston is undertaken. More specifically, exterior surfaces of the clamp pistons are mechanically coupled together through a network of connecting rods. A piston cylinder, within the network of connecting rods, is actuated to cause lateral movement of the rod. This lateral movement is then translated into rotational movement of the clamp piston; the center of rotation of the clamp piston is concentric with the major axis of each corresponding tie bar.

In relation to the periodic rotation of the entire clamp piston, the moment of inertia and, fundamentally, the weight of the clamp piston assembly requires equally robust, physically sizeable and relatively costly drive mechanisms. Consequently, considerable energy is expended in rotating the entire clamp piston, which energy consumption has an impact on manufacturing cost overheads. Moreover, from a manufacturing perspective, the cost for producing a unitary clamp piston is not inexpensive, especially when one considers the inherent complexity and highly-toleranced nature of a relatively large component. Also, in the event of any wear or malfunction in the teeth in the clamp piston, the entire clamp piston assembly has to be replaced, which is both expensive and time consuming.

Today's systems often use hydraulic cylinders to rotate the entire clamp piston. With the high pressure rise rates in these cylinders, such prior art systems are susceptible to high amounts of hydraulic shock. Furthermore, there is an associated high level of noise and a high loading of individual components. Moreover, the locking cylinder force in these prior art systems must be relatively high to overcome the clamp seal force and high moment of inertia of the piston.

U.S. Pat. No. 3,337,921 (Inventor: Kaiser et al; Published: 29 Aug. 1967) discloses an injector for an injection moulding machine, the injector having a cylinder with a forward end and a rear end, a rotating screw for moving the material to be moulded into the cylinder through the rear end thereof, and a piston which is swept along the cylinder to extrude the material through the forward end of the cylinder and through an injection nozzle or orifice.

U.S. Pat. No. 3,396,431 (Inventor: Kovach et al; Published: 13 Aug. 1968) discloses a screw injector that includes a rotatable screw which is axially movable in an extruder barrel and is connected to the piston of a double acting hydraulic cylinder. A motor rotates the screw to effect the axial retraction thereof and actuates a switch at a predetermined retracted position which in turn actuates a valve for an adjustable time to introduce a hydraulic fluid into the cylinder to further axially retract the screw a predetermined distance without rotation thereof whereby to withdraw any of the plastic from the extruder nozzle.

U.S. Pat. No. 6,200,123 (Inventor: Mailliet et al: Published: 2001-03-13) describes a modified clamp piston assembly that includes a rotatable lock bushing mounted within a rotationally fixed, annular clamp piston. An interface between the external surface of the lock bushing and the internal surface of the clamp piston is realised as a screw-thread of inter-engaging teeth. An internal surface of the rotatable lock bushing (also having rows of teeth and corresponding grooves or notches) is arranged to selectively mate with an array of teeth on a outer surface of a push rod, which push rod is used to establish part of the force path for applied closure tonnage (i.e. clamp force). Angular rotation of the lock bushing (between a first position and a second position) therefore either causes engagement or disengagement of the push rod. The lock bushing is mechanically coupled to a turning device (realised by a spline and gear configuration). The turning device is driven by the control of linear actuators that contain racks that operate to engage the gears of the turning device. Whilst this configuration mitigates the requirement to rotate the clamp piston itself, the complexity and reliability of the drive mechanism offsets any potential advantage (particularly fiscal benefit) that is obtained from having a lower power-rated (and hence cheaper) rotational drive mechanism. Moreover, should anything malfunction, then a qualified engineer would expend considerable time in disassembling the combined clamp piston and drive assemblies; and such an extended down-time would be unacceptable in a production environment essentially seeking 24/7 operation.

U.S. Pat. No. 6,767,204 (Inventor: Fuller et al; Published: 1 Aug. 2002) discloses an interlock for a column, including a piston with a piston rod, such that the piston rod is disposed in a claw bush, the claw bush being disposed in a single- or multi-part plate, such that the piston and the claw bush can move in the single- or multi-part plate. In one embodiment, the claw bush has at least two stages, to apply the force in a distributed manner, the contour of the stages corresponding to the end of the piston rod and/or to the end of the column, the average radius of the first stage differing from the average radius of the second stage.

FIG. 1 depicts a known injection molding machine 10. During each injection cycle, the machine 10 produces a number of plastic parts corresponding to a mold cavity or cavities defined by complementary mold halves 12, 14 located within the machine 10. The machine 10 includes, without specific limitation, molding structure, such as a fixed platen 16 and a movable platen 17 as well as an injection unit 18 for plasticizing and injecting material. In operation, the movable platen 17 is moved relative to the fixed platen 16 by means of stroke cylinders (not shown) or the like. Clamp force is developed in the machine, as will readily be appreciated, through the use of tie bars 19, 20 and a tie bar clamping mechanism 21. The tie bar clamping mechanism 21 is (generally) fixedly attached to the movable platen 17 (typically through the use of bolts), with each tie bar clamping mechanism 21 usually extending at least partially into a corresponding bore 22 that extends through the platen at the corners thereof. It is usual that a floating end 23 of the tie bar 19, 20 is free to move relative to the moving platen, with the other remote end anchored into the stationary platen. Of course, in certain systems, the reverse anchoring methodology may be applied.

FIG. 2 depicts a tie bar 19, 20 (which is also known as a column). Proximate to the floating end 23 is a section 24 containing one or more annularly-arranged rows of teeth 25, 26. As previously indicated, each row is punctuated by at least one aligned channel 27, 28. The aligned channels 27, 28 provide an ability for complementary (selectively interlocking) teeth to be drawn or pushed through the channel before relative rotation obtains an interlocking engagement.

Referring back FIG. 1, once the tie bar is positively engaged in its respective clamp piston, mold clamp force (i.e. closure tonnage) can be applied through the use of (typically) a hydraulic system that is usually directly associated with the clamp piston. The mold halves 12, 14 together constitute a mold generally having one or more mold cavities with the mold halves 12, 14 each of which are located in one of the movable platen 17 and the fixed platen 16. A robot 29 is provided, adjacent the fixed platen 16 and movable platen 17, to carry an end of arm tool 30 (hereafter referred to as the “EOAT 30”), such as a vacuum-based take-out plate 32 or the like. In the particular realisation of the vacuum-based take-out plate 32 for preforms, the vacuum-based take-out plate 32 contains a number of cooling tubes 34 at least corresponding in number to the number of preforms 36 (generically called molded articles) produced in each injection cycle of the machine 10.

In use, in a mold open position (as shown in FIG. 1), the robot 29 moves the EOAT 30 into alignment with, typically, a core side of the mold and then waits until molded articles (e.g. preforms 36) are stripped or otherwise ejected from the core(s) into the EOAT 30 by operation of a stripper plate 38, actuator or lift rods or their functional equivalent.

### SUMMARY

According to an exemplary embodiment, there is provided a molding machine that has a clamp piston assembly that includes: (i) a body portion having a channel extending through the body portion, the channel including a pocket into which is mounted, in use, a first set of contact pads, the body portion being transmittable of a clamping force, and (ii) a clamp bushing being receptive of the clamping force from the body portion, the clamp bushing being lockably engagable with a tie bar, the clamp bushing having an external surface to which is mounted, in use, a second set of contact pads, the clamp bushing being locatable and rotatable within the pocket, the first set of contact pads and the second set of contact pads cooperate to define at least two fluid sealable chambers, and responsive to pressurization of fluid placed any one of the at least two fluid sealable, the clamp bushing is rotated so as to become lock engaged with the tie bar. Other embodiments are described in the claims.

Advantageously, a technical effect of the exemplary embodiments is a simplified clamp piston assembly that is actuated by a drive that consumes less energy, and more particularly, reduces the need to spin the entire assembly. Additionally, with the reduced mass that is now spun to engage the tie bar, the clamp piston assembly may operate faster and on a quieter basis. Furthermore, should there by any breakage or wear in the clamp piston assembly, in situ disassembly and replacement is generally simplified and repair costs potentially minimised to the replacement part, rather than a large assembly. Clearly, with the use of the aspects of the present invention, the cost associated with providing an appropriately drive to cause positive engagement of the clamp bushing to the tie bar is reduced, since the power developed by (and energy consumption of) that drive unit is reduced when compared with prior art systems.

The aspects of the present invention further reduces the amount of hydraulic shock that otherwise occurs with systems that rotate the entire clamp piston assembly. Moreover, the aspects of the present invention reduce noise associated with high pressure rise rates in the cylinder and further reduces ancillary component loading.

### DESCRIPTION OF THE DRAWINGS

A better understanding of the exemplary embodiments of the present invention (including alternatives and/or variations thereof) may be obtained with reference to the detailed description of the exemplary embodiments of the present invention along with the following drawings, in which:

FIG. 1 is a schematic representation of a known injection molding machine;

FIG. 2 is a perspective view of a known tie bar used in the injection molding machine of FIG. 1;

FIG. 3 is a perspective, exploded view of a clamp piston assembly according to a preferred embodiment; and

FIG. 4 is a perspective view of the clamp piston assembly of FIG. 3.

### DETAILED DESCRIPTION OF THE EXEMPLARY EMBODIMENTS

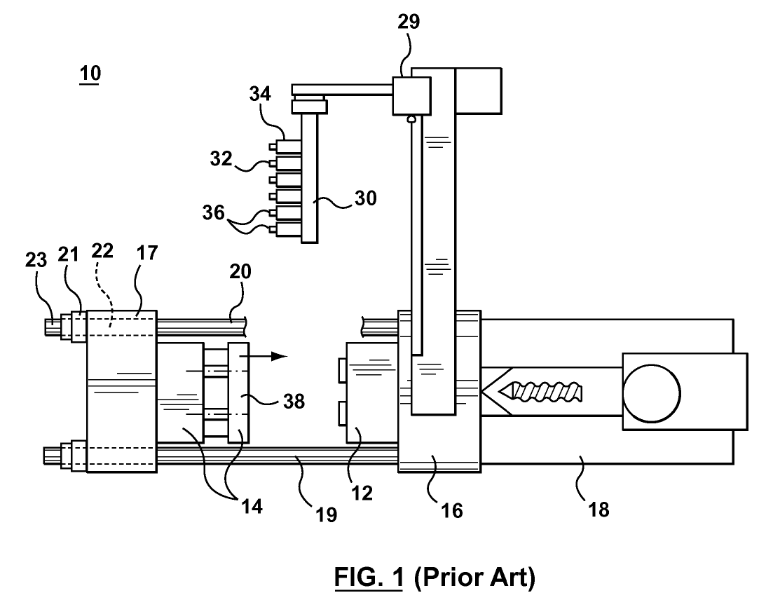

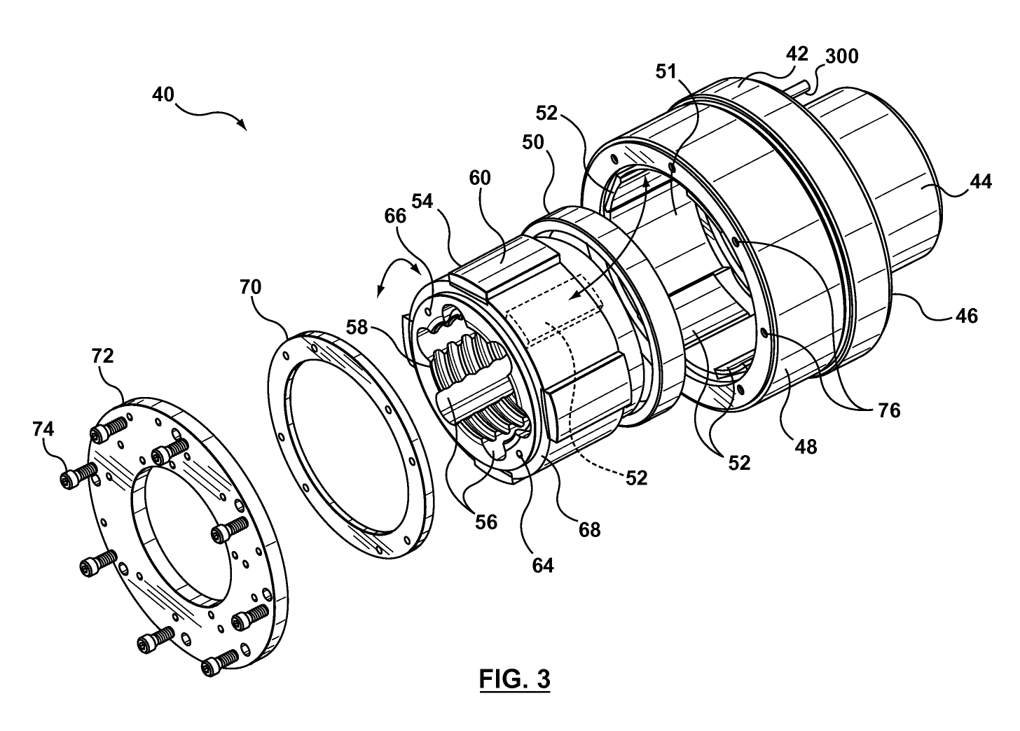

FIG. 3 is the perspective, exploded view of a clamp piston assembly 40 according to a preferred embodiment. The injection molding machine 10 (hereafter referred to as the “machine 10”) is adapted to support the clamp piston assembly 40. Preferably, a platen of the machine 10 is adapted to support the clamp piston assembly 40. The clamp piston assembly 40 includes an annular base 42 that has an annular seat 44 arranged to locate within the bore 22 of the movable platen 17. Abutting the seat is a shoulder 46 that, in use, rests against the edge of the movable platen 17, as shown in FIG. 1. The shoulder 46 has a center concentric with the seat, but has a larger radial diameter. Extending longitudinally from the shoulder 46 is a body portion 48 into which a sealing ring 50 is internally located. The body portion 48 is, preferably cylindrically shaped, and the sealing ring 50 is, preferably removable. The body portion 48 is also called a piston. After the clamp piston assembly 40 has been locked relative to the tie bar, the body portion 48 will linearly slide in response to a hydraulic actuation mechanism imparting a clamping force to the body portion 48, so that, in effect, the clamp piston assembly 40 transmits the clamping force from the hydraulic actuation mechanism to the tie bar 19. The sealing ring 50 abuts into the shoulder 46 justaposed the annular seat 44. The internal diameters of the annular seat 44, body portion 48 and sealing ring 50 are sufficient to permit a tie bar or column to pass unhindered therethrough, i.e. there is a physical separation between these respective surfaces and the tie bar.

A pocket is defined by a surface 51 of the body portion 48. Specifically, the surface 51 is an internal circular surface of the body portion 48. Within the pocket of the body portion 48 are located slots (depicted as longitudinal slots in FIG. 3). These slots receive a first set of contact pads 52 that protrude above the surface 51. The first set of contact pads 52, as will become apparent, act to form a seal with a clamp bushing 54. The clamp bushing 54 is rotated relative to the body portion 48. This will be described in more detail later. The clamp bushing 54 is also called a lock. The clamp bushing 54 is to be rotated between an unlocked position and a locked position. In the locked position, the clamp bushing 54 becomes locked to the tie bar 19 so that the clamping force may then be transmitted from the clamp bushing 54 to the tie bar 19; while in the unlocked position, the clamp bushing 54 becomes unlocked from the tie bar 19 so that the movable platen 17 may move the clamp assembly 40 freely along the tie bar 19. The first set of contact pads are distributed equally about the internal circumference of the surface 51, with there being shown (in the exemplary illustration of FIG. 3) four contact pads that preferably extend lengthways from near (or at) the sealing ring to an open end of the body portion 48.

The annular base 42 and the body portion 48 of the clamp piston assembly 40 are mechanically coupled to the machine 10, which mechanical coupling is typically to a platen and which coupling is achieved through replaceable bolts (to allow disassembly) or the like. An anti-rotation dowel 300 (hereafter referred to as the “dowel 300”) is used to prevent rotation of the body portion 48 relative to the movable platen 17 once the clamp bushing 54 is made to rotate. The dowel 300 extends from the body portion 48 into a platen (either the movable platen or the stationary platen as may be required). The dowel 300 is described further below.

The first set of contact pads 52 are preferably replaceable since, over time, frictional wear may cause degradation in the sealing surface and seal integrity. The contact pads may be made from any suitable material, such as an elastomeric (or elastomer) material or a composite, including carbon fibre or a ceramic. The size and shape of the contact pads can also be varied. As will be understood, my making the contact pads smaller (e.g. narrower), a greater sealing pressure is achieved.

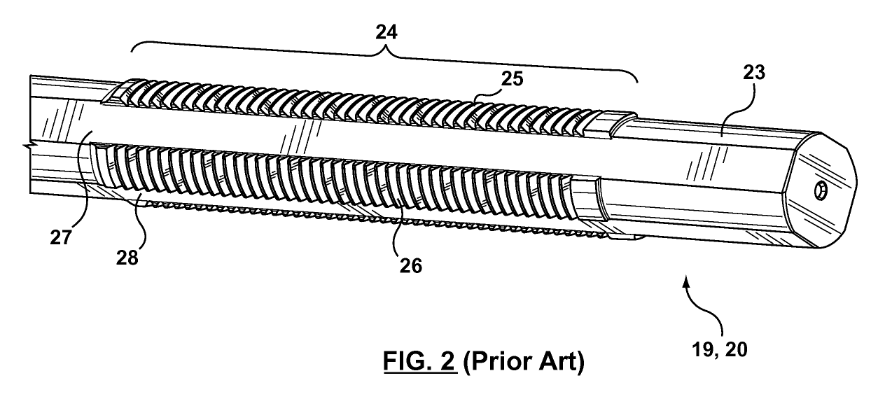

In relation to the clamp bushing 54, which is now effectively produced as an insert, its internal surface contains one or more lateral clearance channels 56 interspersed by at least one row of teeth 58. In the preferred embodiment, multiple rows of teeth are present. The channels 56 and teeth 58 complement the teeth and channels in the tie bar 19, 20 (of FIG. 2) which are designed to be selectably interlocking under clamp up conditions. On an external surface of the clamp bushing 54, a second set of contact pads 60 are deposited. The number and location of such second set of contact pads 60 complements the number and location of the first set of contact pads 52. Again, the size and shape of each contact pad 60 can also be varied, although it is preferably that they extend across the entire width of the clamp bushing to ensure an optimum seal. The second set of contact pads 60 are preferably replaceable since, over time, frictional wear may cause degradation in the sealing surface and seal integrity. The contact pads may be made from any suitable material, such as an elastomer material or a composite, including carbon fibre or ceramic.

To illustrate the locational (functional) inter-relationship between the first set of contact pads and the second set of pads, an image of one of the first set of contact pads 52 has been superimposed (in dotted outline) onto the external surface of the clamp bushing 54. As can be seen, the first set of contact pads 52 therefore fit within the spaces defined by the second set of contact pads 60. The external surface of the clamp bushing 54 therefore includes raised areas of “land” (corresponding to the second set of contact pads) and valleys defined by the external area of the clamp bushing between adjacent contact pads 60.

In a preferred embodiment, the contact pads may have a curved profile that corresponds substantially to an inner curvature of the surface 51 of the body portion 48. In passing, it is noted that increased torque can be achieved by providing additional and/or thicker contact pads, as will be understood. The machine 10 has a hydraulic or pneumatic system. By increasing the thickness (radially) of the contact pads, an increase in projected area of the side of the pads exposed to the hydraulic pressure creates increased torque. Further by adding additional contact pads (that is, greater than the four contact pads as depicted in FIG. 3) more projected areas become available for the fluid to work against, which again increases torque. However, increasing the number of contact pads reduces the amount of radial movement possible and this alternative arrangement may need to be coordinated with the number and spacing of the channels 56 and corresponding tie bar teeth 25 to make a workable arrangement. It is, generally, preferably that the sealing surfaces are, however, as long as possible to mitigate part manufacturing tolerance issues and contact pad wear (arising from frictional forces developed with rotation).

As a result of the structural configuration of the clamp bushing, as attributed particularly to the second set of contact pads, the clamp bushing (upon being inserted into the body portion 48) produces a plurality of chambers defined by and between the first set of contact pads 52 and the second set of contact pads 60. Since the clamp bushing 54 is rotatable within the body portion 48 (relative to the first set of contact pads 52), the various chambers can be varied in volume according to the angular position of clamp bushing relative to the fixed first set of contact pads 52. The clamp bushing 54 is further dimensioned such that it will fit within the body portion 48 and such that there is a seal developed between any one of: (i) the exposed outer surface of the first set of contact pads and the valley area on the clamp bushing 54, and (ii) the raised land regions of each of the second set of contact pads 52 and the surface 51 of the body portion 48. There will be no seal between the opposed faces of the contact pads even when they abut. These pads move towards and away from each other as the clamp bushing 54 rotates. The fluid pressure acting between the pads causes the rotary motion of the clamp bushing 54. Lift points 64-66 may be provided in the clamp bushing 54 to facilitate removal of the clamp bushing 54 from the body portion 38.

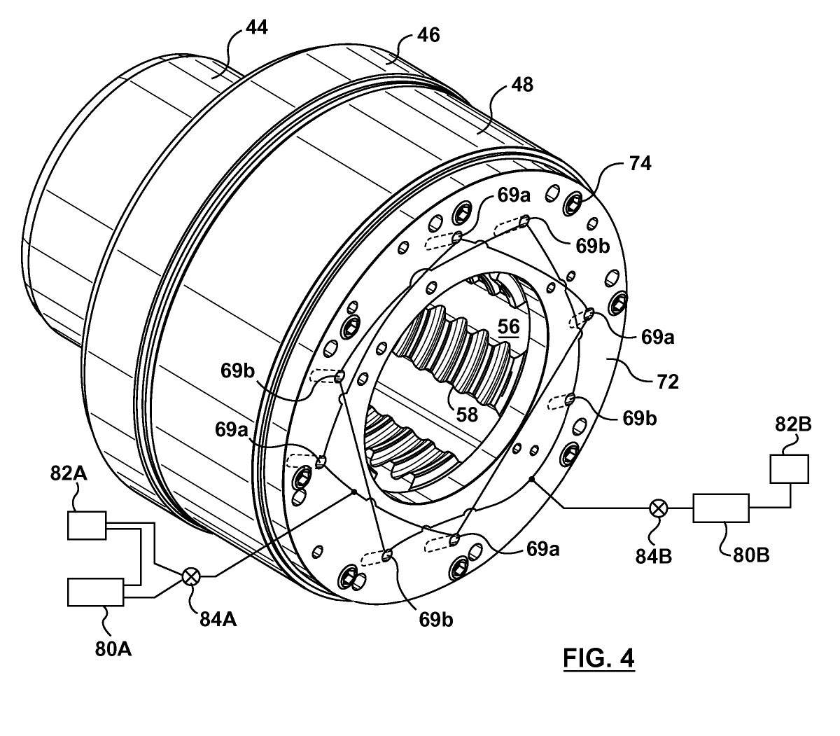

In order to cause rotation of the clamp bushing, at least one valve-controlled conduit for fluid is provided to either side of at least one of the contact pads 52 (that is stationary) so that, when one of the chambers is pressurised, the clamp bushing 54 will rotate. More specifically, by providing a fluid communication path to the chambers defined between the lands and valleys of the clamp bushing, rotational control of the clamp bushing 54 within the body portion 48 is achieved. In a preferred embodiment, the fluid is air, although alternatives are also contemplated, e.g. hydraulic fluid. By subsequently inducing the expulsion of fluid from the (initially) pressurised chamber, and by introducing fluid onto the other side of the contact pad 52 (that is stationary) to pressurize an adjacent chamber, counter-rotation of the clamp bushing is achieved. In a preferred embodiment, the conduits 69a, 69b (which are depicted in FIG. 4) are: (i) formed in the face of the end plate 72, and (ii) penetrate through locating ring 70, which has appropriate seals on both faces, in order to provide a fluid conduit to the chambers between the contact pads, although location of the conduits 69 may be at an alternate point, e.g. through the wall of the body portion 48.

A locating ring 70 (which also acts as a sealing surface) is mechanically coupled to the body portion 48, whereby the locating ring retains the clamp bushing 54 within the body portion 48. The locating ring is further positioned juxtaposed the spigot 68 so that it can support the rotation of the clamp bushing 54. An end plate 72 is coupled (via bolts 74) to the body portion 48; specifically, the bolts 74 engage with respective threaded holes 76 defined the body portion 48.

The clamp piston assembly 40 is then assembled in a suitable cylinder in either the movable platen or the stationary platen (as may be required). Each tie bar is therefore able to pass through the entire assembly and to be selectably positively engaged by rotation of the clamp bushing 54. In a preferred embodiment, it is preferable that the clamp bushing, when located in the body portion 48, is under compressive loading, i.e. that the locating ring 70 and/or the shoulder 46 exhibit spring-like characteristics or include dedicated springs, to ensure good face-sealing contact with the clamp bushing 54.

FIG. 4 depicts the perspective view of the clamp piston assembly 40 in an assembled state. Concerning operational control of the clamp piston assembly 40, the preferred embodiment uses an air compressor or pump (or the like) 80 to selectively inject fluid into the chambers defined between the lands and valleys of the clamp bushing. With effective sealing achieved by the first set of contact pads 52 and the second set of contact pads 60, selective venting and complementary pressure applied to adjacent chambers may be performed by using: (i) a processor 82A that is configured to control a pump 80A and to control a valve 84A (the valve 84A being coupled to the pump 80A) so that fluid may be transmitted to or removed from the conduit 69a, and (ii) a processor 82B that is configured to control a pump 80B and to control a valve 84B (the valve 84B being coupled to the pump 80B) so that fluid may be transmitted to or removed from the conduit 69b. It will be appreciated that when the pump 80A is operated to push fluid into the conduit 69a, the pump 80B is operated to pull fluid from the conduit 69b (and visa versa) so that rotation of the clamp bushing 54 may be achieved. The fluid pressure (preferably air pressure) in the adjacent chambers provides sufficient force against an edge of the second set of contact pads 60 to cause rotation of the clamp bushing 54 and hence to achieve engagement or disengagement of the respective teeth on the clamp bushing 54 and tie bar 19, 20. The conduits 69 are therefore divided into two sets (denoted as 69a and 69b) that are utilised in a complementary, valve-controlled basis. Furthermore, with processor control, fluid can be metered out to damp (i.e. act as a cushion to avoid) shock and vibration arising from clamp bushing rotation. Sensors may be used to determine angular and positional information of the clamp assembly 40. A first sensor (such a Temposonic™ rod supplied by MTS Systems Corporation, Sensors Division, Cary, N.C. 27513, USA; www.mtssensors.com) may be mounted to the end plate 72 so that the first sensor may be used to detect linear movement and/or linear position of the body portion 48. A second sensor (such as a proximity probe) may be mounted to the clamp bushing 54 so that the second sensor may be used to detect angular position and/or angular displacement of the clamp bushing 54. The purpose of the dowel 300 is to (once any one of the conduits 69a, 69b are pressurized with fluid): (i) prevent rotation of the body portion 48, and (ii) permit rotation of the clamp bushing 54. In this manner, the dowel 300 prevents rotation of the body portion 48 should the clamp bushing 54 become prevented from rotating when any one of the conduits 69a, 69b are pressurized with fluid.

It will be appreciated that, for operation, it is necessary to produce a minimum of two chambers between the respective sets of contact pads on the exterior surface of the clamp bushing and the interior surface of the pocket (in the body portion 48).

It is noted that, for the sake of clarity only, the complementary inter-relationship between the two sets of conduits 69a, 69b has been illustrated schematically. Also, from a practical perspective of the preferred embodiment, once the clamp piston assembly 40 is assembled, the conduits 69 are preferably located besides (i.e. in relatively close proximity to) the contact pads 52 (that is stationary, and/or their functional equivalent).

In contrast with prior art systems, a rotation drive system (preferably air-driven) is located between the body portion 48 per se and the outer surface of the clamp bushing 54 (or lock ring). With the present invention now providing an integral rotary engagement mechanism in the form of an insert inside the clamp piston assembly 40, energy requirements to drive engagement and disengagement of the clamp and tie bar (or column) are therefore reduced to simply overcome the load realised by the weight of the clamp bushing 54 in combination with any drag forces (associated with sealing contacts and residual air pressure in a chamber); this is very much lower than in existing systems.

Referring to FIG. 3, the body portion 48 is movable laterally (under the influence of the clamping force imparted to the body portion 48 from a hydraulic actuation mechanism), while the clamp bushing 54 (provided as an insert) is independently rotatable relative to the body portion 48.

By way of overview of the in situ operation of the preferred embodiment of the present invention, a pad structure on both the inner surface of the clamp piston and the external surface of the rotatable clamp bushing (or lock ring) cooperate to allow the clamp bushing (bearing teeth and channels) to selectively engage teeth on a tie bar. The clamp bushing is therefore effectively reduced to a replaceable insert within a clamp piston body. Through the control of pressure into the chambers formed by seals realized between the various pads (or their functional equivalent), relative rotational movement is achieved between the body portion 48 and the clamp bushing 54. The pads on the clamp bushing 54 therefore essentially act to provide piston surfaces.

It will, of course, be appreciated that the above description has been given by way of example only and that modifications and variations will be readily apparent to the skilled exponent without departing from the scope of the appended claims. For example, whilst the preferred embodiment has been described in the context of a tie bar in a 2-platen injection molding environment, the present invention can equally easily find application in the securing of a central column (in a 3-platen design) or in other equivalent press-like systems in which a clamping cycle is succeeded by some form of relative movement between the piston and tie bar (or the like). Equally, the present invention can find application in specific forms of press-based technology, including (but not limited to) thixomolding and blow molding, over a variety of closure pressures from tens to thousands of metric tons. Additionally, whilst the preferred embodiment has been described in the context of two sets of contact pads, it is also possible for the pads to be realised by a fixed set of “lands” and a complementary set of contact pads or blades (or their functional equivalent) that are arranged to engage these lands to produce the sealing surface. Of course, the optimum solution is to provide the largest sealing surface to define the various discrete fluid-tight chambers between the external surface of the clamp bushing and the internal surface of the annular base. Furthermore, whilst the preferred embodiment has been described in relation to a pneumatically-driven system, it is conceivable that rotation of the clamp bushing 54 could be influenced and controlled by a hydraulic system.

In the context of the present invention, therefore, the term “contact pad” or “pad” should be considered to include and embrace any functional variant (e.g. a blade or land) that acts to allow the production of a sealed chamber (whose volume can be varied by relative rotation) between the internal surface of the body portion 48 and the clamp bushing 54.

What is claimed is:

1. A molding machine, comprising:
a piston assembly including:
a body portion; and
a clamp bushing containing a rotational drive system, the clamp bushing insert independently rotatable with respect to the body portion, the clamp bushing insert containing an engagement mechanism arranged, in use, to positively engage one of a tie bar and a column, the body portion includes a pocket in which the clamp bushing is located, the rotational drive system is located between an inner surface of the pocket and an outer surface of the clamp bushing insert, and the rotational drive system includes a plurality of outwardly extending contact pads being coupled to the surface of the clamp bushing.

2. A molding machine, comprising:
a clamp piston assembly including:
a body portion having a channel extending through the body portion, the channel including a pocket into which is mounted, in use, a first set of contact pads, the body portion being transmittable of a clamping force; and
a clamp bushing being receptive of the clamping force from the body portion, the clamp bushing being lockably engagable with a tie bar, the clamp bushing having an external surface to which is mounted, in use, a second set of contact pads, the clamp bushing being locatable and rotatable within the pocket, the first set of contact pads and the second set of contact pads cooperate to define at least two fluid sealable chambers, and responsive to pressurization of fluid placed any one of the at least two fluid sealable, the clamp bushing is rotated so as to become lock engaged with the tie bar.

3. An article made by the usage of the molding machine of claim 2.

4. The molding machine of to claim 2, wherein at least one of the first set of contact pads and the second set of contact pads are removable.

5. The molding machine of claim 2, wherein the second set of contact pads define at least two valley regions and at least two raised land regions on the clamp bushing, and wherein the pocket has an internal surface and the first set of contact pads and the second set of contact pads develop a sealing surface between any one of:
an exposed outer surface of the first set of contact pads and the least two valley regions on the clamp bushing; and
the least two raised land regions of the second set of contact pads 52 and the internal surface of the body portion.

6. The molding machine of claim 2, further including a locating ring coupled to the body portion, whereby the locating ring retains the clamp bushing within the body portion.

7. The molding machine of claim 6, wherein the locating ring further acts as a sealing surface with respect to at least one of the first set of contact pads and the second set of contact pads.

8. The molding machine of claim 2, further including fluid conduits in fluid communication with each of the at least two fluid sealable chambers, the fluid conduits located on either side of each of the first set of contact pads.

9. The molding machine of claim 8, further including at least one valve for controlling fluid flow through the fluid conduits.

10. The molding machine of claim 2, further including a sealing ring located within the pocket but constrained within the pocket by the clamp bushing.

11. The molding machine of claim 2, wherein the body portion further includes a seat that abuts against a shoulder, the seat arranged to locate, in use, into a bore of a platen.

12. The molding machine of claim 2, wherein the clamp bushing has an internal surface having a circumference, the internal surface including:
teeth extending at least partially around the circumference; and
at least one channel extending through the teeth.

13. The molding machine of claim 2, wherein the first set of contact pads and the second set of contact pads are made from one of: an elastomeric material; carbon fibre; and a ceramic.

14. A molding machine, comprising:
a clamp bushing of a clamp piston assembly including a body portion having a channel extending through the body portion, the channel including a pocket into which is mounted, in use, a first set of contact pads, the body portion being transmittable of a clamping force,
the clamp bushing being receptive of the clamping force from the body portion, the clamp bushing being lockably engagable with a tie bar, the clamp bushing having an external surface to which is mounted, in use, a second set of contact pads, the clamp bushing being locatable and rotatable within the pocket, the first set of contact pads and the second set of contact pads cooperate to define at least two fluid sealable chambers, and responsive to pressurization of fluid placed any one of the at least two fluid sealable, the clamp bushing is rotated so as to become lock engaged with the tie bar.

15. An article made by the usage of the molding machine of claim 14.

16. A molding machine, comprising:
a body portion of a clamp piston assembly, the body portion having:
a channel extending through the body portion, the channel including a pocket into which is mounted, in use, a first set of contact pads, the body portion being transmittable of a clamping force, the clamp piston assembly having a clamp bushing being receptive of the clamping force from the body portion, the clamp bushing being lockably engagable with a tie bar, the clamp bushing having an external surface to which is mounted, in use, a second set of contact pads, the clamp bushing being locatable and rotatable within the pocket, the first set of contact pads and the second set of contact pads cooperate to define at least two fluid sealable chambers, and responsive to pressurization of fluid placed any one of the at least two fluid sealable, the clamp bushing is rotated so as to become lock engaged with the tie bar.

17. An article made by the usage of the molding machine of claim 16.

18. A molding machine, comprising:
a platen including:
a clamp piston assembly including:
a body portion having a channel extending through the body portion, the channel including a pocket into which is mounted, in use, a first set of contact pads, the body portion being transmittable of a clamping force; and
a clamp bushing being receptive of the clamping force from the body portion, the clamp bushing being lockably engagable with a tie bar, the clamp bushing having an external surface to which is mounted, in use, a second set of contact pads, the clamp bushing being locatable and rotatable within the pocket, the first set of contact pads and the second set of contact pads cooperate to define at least two fluid sealable chambers, and responsive to pressurization of fluid placed any one of the at least two fluid sealable, the clamp bushing is rotated so as to become lock engaged with the tie bar.

19. An article made by the usage of the molding machine of claim 18.

20. A molding machine, comprising:
a clamp piston assembly including:
a body portion having a channel extending through the body portion, the channel including a pocket into which is mounted, in use, a first set of contact pads, the body portion being transmittable of a clamping force; and
a clamp bushing being receptive of the clamping force from the body portion, the clamp bushing being lockably engagable with a tie bar, the clamp bushing having an external surface to which is mounted, in use, a second set of contact pads, the clamp bushing being locatable and rotatable within the pocket, the first set of contact pads and the second set of contact pads cooperate to define at least two fluid sealable chambers, and responsive to pressurization of fluid placed any one of the at least two fluid sealable, the clamp bushing is rotated so as to become lock engaged with the tie bar.

21. An article made by the usage of the molding machine of claim 20.

22. A method of a molding machine, the molding machine having a clamp piston assembly including: (i) a body portion having a channel extending through the body portion, the channel including a pocket into which is mounted, in use, a first set of contact pads, the body portion being transmittable of a clamping force; and (ii) a clamp bushing being lockably engagable with a tie bar, the clamp bushing having an external surface to which is mounted, in use, a second set of contact pads, the clamp bushing being locatable and rotatable within the pocket, the first set of contact pads and the second set of contact pads cooperate to define at least two fluid sealable chambers, the method comprising:
pressurizing fluid placed any one of the at least two fluid sealable, responsive to pressurizing the fluid, the clamp bushing is rotated so that the clamp bushing become lock engaged with the tie bar; and
transmitting the clamping force through the body portion to the clamp bushing so that the clamping force becomes imparted to the tie bar.

23. An article made by the usage of the molding machine of claim 22.
